(19) United States
(12) Patent Application Publication
(10) Pub. No.: US 2012/0231364 A1
(43) Pub. Date: Sep. 13, 2012

(54) CATHODE FOR MOLTEN CARBONATE FUEL CELL AND MANUFACTURING METHOD OF THE SAME

(75) Inventors: Jong Hee HAN, Seoul (KR); Shin Ae SONG, Seoul (KR); Sung Pil YOON, Gyeonggi-do (KR); Suk Woo NAM, Seoul (KR); Tae Hoon LIM, Seoul (KR); In Hwan OH, Seoul (KR); Dae Ki CHOI, Seoul (KR); Seong Ahn HONG, Seoul (KR); Chang Won YOON, Seoul (KR)

(73) Assignee: KOREA INSTITUTE OF SCIENCE AND TECHNOLOGY, Seoul (KR)

(21) Appl. No.: 13/353,471

(22) Filed: Jan. 19, 2012

(30) Foreign Application Priority Data
Mar. 10, 2011 (KR) 10-2011-0021277

(51) Int. Cl. H01M 8/14; C23C 4/00; H01M 8/00; B05D 5/12

(52) U.S. Cl. 429/478; 427/77; 427/78

(57) ABSTRACT

Provided is a cathode for molten carbonate fuel cells, including a porous nickel-based electrode containing nickel particles, and metal particles coated on the electrode, wherein at least a part of the metal particles are attached to the surface of the nickel particles. A method for preparing the same is also provided. The cathode for molten carbonate fuel cells accelerates the cathodic oxygen reduction and reduces polarization resistance occurring at the cathode, thereby providing a fuel cell with improved performance even at low temperature. Additionally, it is possible to improve the service life of a molten carbonate fuel cell due to such low operation temperature.

### CROSS-REFERENCE TO RELATED APPLICATION

This application claims priority to Korean Patent Application No. 10-2011-0021277, filed on Mar. 10, 2011, and all the benefits accruing therefrom under 35 U.S.C. §119, the contents of which in its entirety are herein incorporated by reference.

### BACKGROUND

1. Field

The present disclosure relates to a cathode for molten carbonate fuel cells and a method for manufacturing the same, and more particularly to a cathode for molten carbonate fuel cells, which has metal coating and shows high performance even at low temperature, and a method for manufacturing the same.

2. Description of the Related Art

In general, fuel cells are devices by which chemical energy of chemical fuel is converted directly into electric energy, and have high efficiency and eco-friendly characteristics. Among such fuel cells, molten carbonate fuel cells applied to high temperature are operated at a high temperature of about 650° C., and thus have advantages, which, otherwise, may not be expected from low-temperature type fuel cells, such as phosphoric acid fuel cells and polymer fuel cells. Since molten carbonate fuel cells accomplish electrochemical reactions rapidly at high temperature, they allow the use of inexpensive nickel as an electrode material instead of expensive platinum, thereby providing high cost-efficiency. In addition, platinum electrodes merely allow the use of hydrogen as fuel due to such problems as poisoning with carbon monoxide. However, nickel electrodes allow the use of various types of fuel, including coal gas, natural gas, methanol and biomass, thereby providing higher cost-efficiency than other types of fuel cells.

Oxidation of hydrogen and reduction of oxygen occur in a molten carbonate fuel cell in the manner as depicted in the following chemical formulae:

H₂+CO₃²⁻→H₂O+CO₂+2e⁻ (Hydrogen oxidation)

½O₂+CO₂+2e⁻→CO₃²⁻ (Oxygen reduction)

In the anode of a molten carbonate fuel cell, hydrogen is oxidized while donating electrons. In the cathode, oxygen is reduced while accepting the electrons. Herein, the anodic oxidation of hydrogen occurs more slowly than the cathodic reduction of oxygen. Therefore, cathode polarization is larger than anode polarization, resulting in degradation of the performance of the fuel cell.

A cathode that has been used in molten carbonate fuel cell according to the related art is obtained by forming a porous shaped nickel electrode, assembling a cell, and injecting reaction gas thereto to carry out in-situ conversion into lithiated NiO. In other words, the porous shaped nickel electrode mounted in the cell during the assemblage reacts with the reaction gas, oxygen in the air to form nickel oxide, and reacts with lithium carbonate present in an electrolyte at the same time to be converted into porous lithiated NiO. Herein, nickel oxide itself has little electrical conductivity but reacts with lithium in the electrolyte to induce lithiation, resulting in a rapid increase in conductivity, so that it may be used as a cathode for molten carbonate fuel cells. In the case of in-situ lithiated NiO as a cathode for molten carbonate fuel cells according to the related art, oxygen reduction occurs more slowly than hydrogen oxidation. This causes a significant drop in performance of a fuel cell as compared to theoretically expected performance. Such cathodes according to the related art have a low oxygen reduction rate, which is a main factor determining the performance of a fuel cell. As a result, there has been a continuous need for providing a novel cathode capable of inducing rapid oxygen reduction. In addition, when the high polarization resistance of a cathode is reduced, it is possible to obtain such expected performance of a fuel cell even at an operation temperature of 600-620° C., which is lower than the currently used operation temperature. Since lower operation temperature may pose reduced fatigue on electrode materials and may decrease evaporation of an electrolyte, it is favorable to long-term operation and contributes to reduction of cost required to operation.

Under these circumstances, there has been a need for a novel cathode that reduces cathode polarization resistance through a high oxygen reduction rate to improve the performance of a fuel cell, while allowing stable operation of a cell over a long period of operation time.

### SUMMARY

The present disclosure is directed to providing a cathode for molten carbonate fuel cells, the cathode having electro-conductive metal coating on the surface thereof to accelerate the oxygen reduction at a fuel cell cathode, thereby providing stable high performance even at low operation temperature.

In one aspect, there is provided a cathode for molten carbonate fuel cells, including a porous nickel-based electrode containing nickel particles, and metal particles coated on the electrode, wherein at least a part of the metal particles are attached to the surface of the nickel particles.

According to an embodiment of the cathode disclosed herein, the metal particles may be at least one selected from the group consisting of silver (Ag), gold (Au), copper (Cu), platinum (Pt), titanium (Ti) and cobalt (Co), and may have a diameter of 0.001 nm-2 μm.

In another aspect, there is provided a method for manufacturing a cathode for molten carbonate fuel cells, including:

dispersing metal particles into a solvent to provide a coating solution; and

applying the coating solution of metal particles onto a porous nickel-based electrode.

According to an embodiment of the method disclosed herein, the method may further include drying the porous nickel-based electrode having the metal particles applied thereon.

### BRIEF DESCRIPTION OF THE DRAWINGS

The above and other aspects, features and advantages of the disclosed exemplary embodiments will be more apparent from the following detailed description taken in conjunction with the accompanying drawings in which:

FIG. 1 is a photographic view of a metal-coated cathode for molten carbonate fuel cells according to an embodiment, taken by scanning electron microscopy (SEM), wherein portion (a) shows a non-coated cathode, portion (b) shows a silver (Ag)-coated cathode and portion (c) shows a copper (Cu)-coated cathode;

FIG. 2 is a graph showing the performance and power density of a unit cell using a Ag-coated cathode for molten carbonate fuel cells according to an embodiment, as a function of operation temperature;

FIG. 3 is a graph showing the performance and power density of a unit cell using a Cu-coated cathode for molten carbonate fuel cells according to an embodiment, as a function of operation temperature; and

FIG. 4 is a graph showing the performance and power density of a unit cell using a non-coated cathode for molten carbonate fuel cells, as a function of operation temperature.

### DETAILED DESCRIPTION

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art. In the description, details of well-known features and techniques may be omitted to avoid unnecessarily obscuring the presented embodiments.

In one aspect, there is provided a cathode for molten carbonate fuel cells, including a porous nickel-based electrode containing nickel particles, and metal particles coated on the electrode, wherein at least a part of the metal particles are attached to the surface of the nickel particles.

The nickel-based electrode is formed by nickel particles and has a porous structure due to the interstitial volumes among the nickel particles. The nickel-based electrode may be a porous nickel plate containing lithium in an amount less than 5 wt %.

The metal particles may be at least one selected from the group consisting of silver (Ag), gold (Au), copper (Cu), platinum (Pt), titanium (Ti) and cobalt (Co). More particularly, the metal particles may be Ag or Cu particles, but are not limited thereto.

The metal particles may have a diameter of 0.001 nm-2 μm, particularly 0.001 nm-0.5 μm. When the metal particles have a diameter less than 0.001 nm, it is difficult to disperse and apply them due to their difficulty in handling. On the other hand, when the metal particles have a diameter larger than 2 μm, they may occlude the pores of the nickel electrode because the pores have a size of about 4-10 μm. Thus, it is difficult to apply the metal particles having such a large diameter onto the surface of the nickel electrode.

The metal particles may be present in the porous nickel-based electrode in an amount of 0.05-30 parts by weight, particularly 0.1-20 parts by weight, based on 100 parts by weight of the porous nickel-based electrode. When the metal particles are present in an amount less than 0.05 parts by weight, it is not possible to improve the performance of a cathode, because the metal particle content is too low to provide a sufficient effect of metal particles. On the other hand, when the metal particles are present in an amount more than 30 parts by weight, a portion of the metal particles, which may remain after applying the metal particles onto the nickel electrode surface, may occlude the pores in the electrode and interrupt the transfer of gas, resulting in degradation of the performance of the electrode.

The cathode may have a porosity of 50-85%. When the porosity is lower than 50%, it is not possible for reaction gas to flow sufficiently into the electrode, thereby causing over-load to electrode reactions and degradation of the performance of the electrode. On the other hand, when the porosity is higher than 85%, the electrode may experience a drop in mechanical strength, and thus may cause cracking and so on.

Further, the pores in the cathode may have a size of 4-15 μm. When the pore size is smaller than 4 μm, resistance against mass transfer occurs when reaction gas flows into the electrode, thereby causing over-load to electrode reactions and degradation of the performance of the electrode. On the other hand, when the pore size is greater than 15 μm, the electrode may have a decreased effective reaction area, resulting in degradation of the performance of the electrode.

In another aspect, there is provided a method for manufacturing a cathode for molten carbonate fuel cells, including:

dispersing metal particles into a solvent to provide a coating solution; and

applying the coating solution of metal particles onto a porous nickel-based electrode.

The method may further include drying the porous nickel-based electrode having the metal particles applied thereon.

Particular examples of the solvent used in dispersing the metal particles into a solvent to provide a coating solution may include a mixture of toluene with ethanol. However, any solvents known to those skilled in the art may be used with no particular limitation. In addition, a dispersing agent may be added to disperse the metal particles into the solvent, and particular examples of the dispersing agent may include BYK-110 (BYK Co., Germany), DIPERBYK-110 (BYK Co., Germany), or the like.

The metal particles may be at least one selected from the group consisting of Ag, Au, Cu, Pt, Ti and Co, particularly, Ag or Cu, but are not limited thereto.

The metal particles are dispersed into the solvent to provide a coating solution. The coating solution may be slurry, but is not limited thereto. The coating solution may have a viscosity of 0.3-100 cp. When the coating solution has a viscosity lower than 0.3 cp, the metal particle coating solution flows too fast on the electrode to perform sufficient coating thereon. On the other hand, when the coating solution has a viscosity higher than 100 cp, it may flow into the pores inside the nickel electrode, thereby making it difficult to perform coating of the metal particles.

Thereafter, the metal particle coating solution thus obtained is applied onto a porous nickel-based electrode. Such application may be carried out by spray coating, dip coating, spin coating, sol-gel and vacuum suction processes, but is not limited thereto. The above-mentioned processes are known to those skilled in the art. According to the method disclosed herein, slurry in which nanomicron- to submicron-scaled small metal particles are dispersed is coated on the porous nickel-based electrode via pouring or dipping. Therefore, it is possible to maintain the pore size and porosity of the original electrode to the same extent as in conventional cathodes.

After the metal particle coating solution is applied onto the porous nickel-based electrode, the coating solution is allowed to infiltrate into the internal pores, followed by drying.

Molten carbonate fuel cells are specifically operated at a high temperature of 650° C. In other words, since molten carbonate fuel cells are operated at a higher temperature than other low temperature-type fuel cells, cathodic oxygen reduction of such molten carbonate fuel cells occurs more promptly than that of other low temperature-type fuel cells, but more slowly than anodic hydrogen oxidation of such molten carbonate fuel cells. The cathode disclosed herein accelerates oxygen reduction, thereby improving overall performance of the cell using the same.

In addition, the cathode disclosed herein solves the problem of degradation of the performance in a molten carbonate fuel cell caused by high polarization resistance of the cathode according to the related art. According to an embodiment, a shaped nickel electrode is coated with small metal particles, such as Ag or Cu, wherein the nickel template is converted into lithiated NiO in-situ inside a cell. In other words, the surface of a conventional porous shaped nickel electrode is coated with highly conductive small metal particles, such as Ag or Cu, to realize reduced polarization resistance as compared to the cathode according to the related art. In this manner, it is possible to improve the performance and service life of a cell.

### EXAMPLES

The examples and experiments will now be described. The following examples and experiments are for illustrative purposes only and not intended to limit the scope of the present disclosure.

### Example 1

### Manufacture of Ag-Coated Cathode for Molten Carbonate Fuel Cells

In this example, a shaped nickel electrode is coated with a solution (Advanced Nano Products Co., Ltd., Korea) containing Ag having a size of 30-100 nm dispersed therein via a vacuum suction process to provide a cathode.

First, filter paper is placed inside a Buchner funnel, a frame conformed to the size of an electrode is fabricated, and the frame is laid on the filter paper inside of the funnel together with a porous nickel-based electrode. Next, a diluted Ag dispersion, obtained by diluting the commercially available Ag dispersion with ethanol solvent to a dilution factor of 5, is poured gradually over the whole part of the pores of the electrode to facilitate coating. After maintaining vacuum suction for 30 minutes, the coated electrode is dried in an oven at 80° C. for approximately 1 hour to finish a Ag-coated electrode. The final Ag coating amount is set to about 3 wt % based on the weight of the nickel-based electrode.

### Example 2

### Manufacture of Cu-Coated Cathode for Molten Carbonate Fuel Cells

In this example, a shaped nickel electrode is coated with a solution containing Cu having a size of 100-150 nm dispersed therein via a vacuum suction process to provide a cathode.

First, Cu powder is introduced into an ethanol solution containing a dispersing agent (BYK-110), and subjected to dispersion in an ultrasonic bath for about 1 hour. Next, filter paper is placed inside a Buchner funnel, a frame conformed to the size of an electrode is fabricated, and the frame is laid on the filter paper inside of the funnel together with a porous nickel-based electrode. Next, the Cu dispersion is poured gradually over the whole part of the pores of the electrode to facilitate coating. After maintaining vacuum suction for 30 minutes, the coated electrode is dried in an oven at 80° C. for approximately 1 hour to finish a Cu-coated electrode. The final Cu coating amount is set to about 3 wt % based on the weight of the nickel-based electrode.

### Comparative Example 1

The non-coated porous nickel-based electrode used in Example 1 is taken as the cathode of Comparative Example 1.

### TEST EXAMPLES

### Test Example 1

### Scanning Electron Microscopy (SEM) of Cathodes

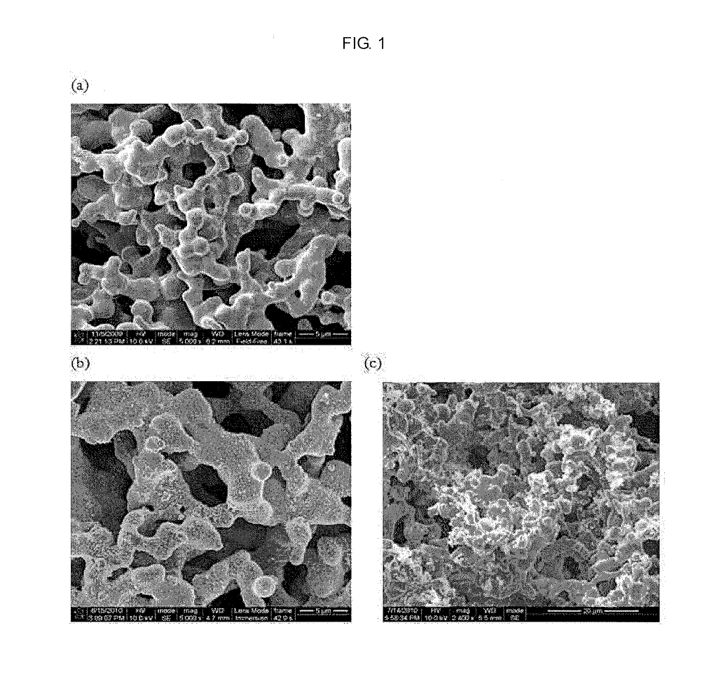

The cathodes obtained from Examples 1 and 2 and Comparative Example 1 are analyzed by SEM. The results are shown in FIG. 1, wherein portion (a) shows the cathode of Comparative Example 1, portion (b) shows the Ag-coated cathode of Example 1, portion (c) shows the Cu-coated cathode of Example 2.

As shown in FIG. 1, Ag particles are distributed uniformly over the whole surface of the nickel electrode, while Cu particles are agglomerated among themselves and positioned sparsely on the nickel electrode.

### Test Example 2

### Determination of Performance of Unit Cell

1) Determination of Performance of Unit Cell

The cathodes obtained from Examples 1 and 2 and Comparative Example 1 are used to assembly unit cells. Then, the performance of each unit cell depending on the cell operation temperature and the internal resistance of each unit cell are determined during the cell operation.

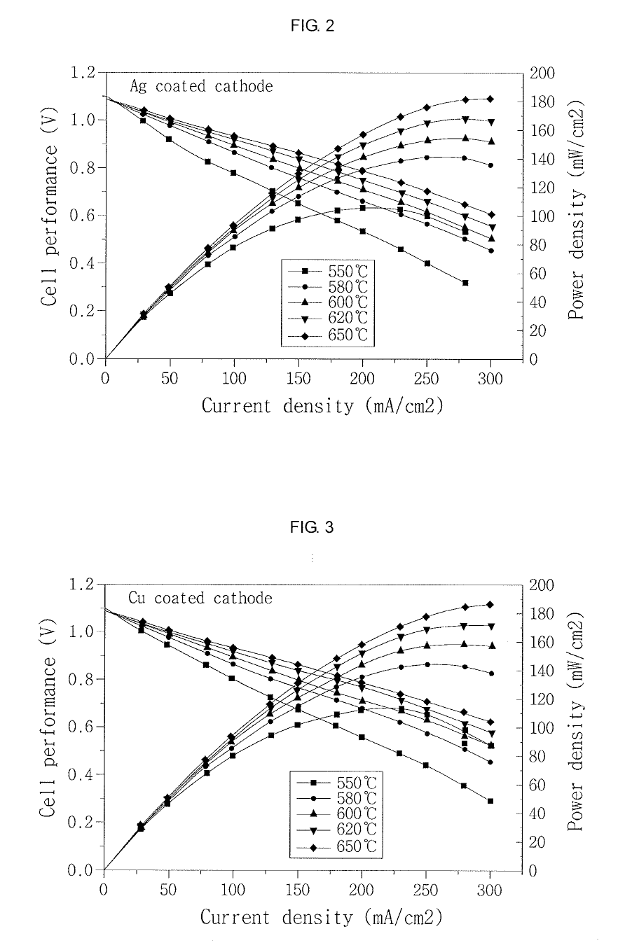

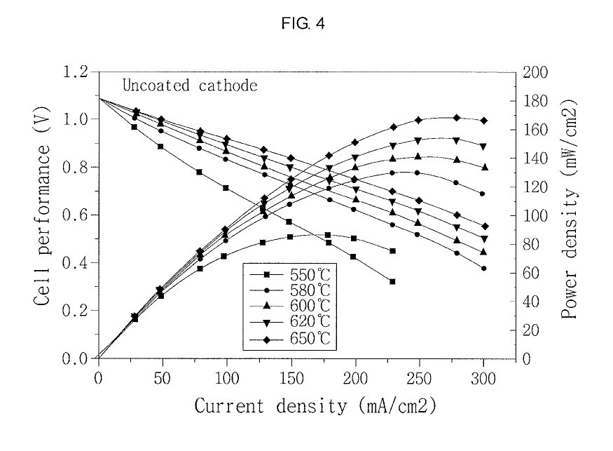

The performance of each unit cell is shown as a function of temperature in FIGS. 2 to 4 (FIG. 2: Example 1, FIG. 3: Example 2, and FIG. 4: Comparative Example 1). In addition, the following Table 1 shows the results of the performance of each unit cell as a function of temperature under a current density of 150 mA/cm².

TABLE 1

| | | | Comparative |
|---|---|---|---|
| Temperature | Example 1 (V) | Example 2 (V) | Example 1 (V) |
| 550° C. | 0.649 | 0.675 | 0.567 |
| 580° C. | 0.756 | 0.767 | 0.723 |
| 600° C. | 0.797 | 0.803 | 0.763 |
| 620° C. | 0.834 | 0.838 | 0.805 |
| 650° C. | 0.861 | 0.860 | 0.838 |

At an operation temperature of 550° C., the unit cell using the cathode of Comparative Example 1 shows a voltage of 0.567 V, while the unit cells using the cathodes of Example 1 (Ag) and Example 2 (Cu) show a voltage of 0.649 V and 0.675 V, respectively. It can be seen from the above results that the Ag- or Cu-coated cathode provides improved performance even at low temperature. At a higher operation temperature, the unit cells using the Ag- or Cu-coated cathodes provide improved performance by an increment of about 20-40 mV. This suggests that the cathodes coated with metal particles, such as Ag or Cu, realize improved performance even at low temperature, and thus may be used as cathodes for high-performance molten carbonate fuel cells.

2) Determination of Internal Resistance

The unit cells using the cathodes of Examples 1 and 2 and Comparative Example 1 are tested for their internal resistance (IR) values, and the results are shown in the following Table 2. As can be seen from Table 2, the Ag-coated cathode of Example 1 has a significantly decreased average IR of 3.2 mΩ, while the non-coated cathode has an average IR of 4.5 mΩ. It is thought that such a decrease in IR results from the cathode having high conductivity due to the presence of the highly conductive metal, Ag.

TABLE 2

| | | | Comparative |
|---|---|---|---|
| | Example 1 (mΩ) | Example 2 (mΩ) | Example 1 (mΩ) |
| IR | 3.2 | 3.7 | 4.5 |

According to the method for manufacturing a cathode for molten carbonate fuel cells disclosed herein, it is possible to carry out uniform coating of metal on the surface of a porous nickel electrode, thereby providing a cathode for molten carbonate fuel cells which accelerates the cathodic oxygen reduction, realizes improved performance and has long service life.

In addition, the metal-coated cathode for molten carbonate fuel cells disclosed herein accelerates the cathodic oxygen reduction even at low operation temperature and reduces polarization resistance occurring at the cathode, thereby providing a fuel cell with improved performance even at low temperature. Further, it is possible to improve the service life of a molten carbonate fuel cell due to such low operation temperature.

What is claimed is:

1. A cathode for molten carbonate fuel cells, comprising a porous nickel-based electrode containing nickel particles, and metal particles coated on the electrode, wherein at least a part of the metal particles are attached to the surface of the nickel particles.

2. The cathode for molten carbonate fuel cells according to claim 1, wherein the metal particles include at least one selected from the group consisting of silver (Ag), gold (Au), copper (Cu), platinum (Pt), titanium (Ti) and cobalt (Co).

3. The cathode for molten carbonate fuel cells according to claim 1, wherein the metal particles are present in an amount of 0.05-30 parts by weight based on 100 parts by weight of the porous nickel-based electrode.

4. The cathode for molten carbonate fuel cells according to claim 1, wherein the metal particles have a diameter of 0.001 nm-2 μm.

5. The cathode for molten carbonate fuel cells according to claim 1, which has a porosity of 50-85%.

6. The cathode for molten carbonate fuel cells according to claim 1, wherein the pores in the cathode have a size of 4-15 μm.

7. A method for manufacturing a cathode for molten carbonate fuel cells, comprising:
dispersing metal particles into a solvent to provide a coating solution; and
applying the coating solution of metal particles onto a porous nickel-based electrode.

8. The method for manufacturing a cathode for molten carbonate fuel cells according to claim 7, which further comprises drying the porous nickel-based electrode having the metal particles applied thereon.

9. The method for manufacturing a cathode for molten carbonate fuel cells according to claim 7, wherein the coating solution has a viscosity of 0.3-100 cp.

10. The method for manufacturing a cathode for molten carbonate fuel cells according to claim 7, wherein said applying the coating solution of metal particles is carried out by any one process selected from the group consisting of spray coating, dip coating, spin coating and vacuum suction processes.

11. The method for manufacturing a cathode for molten carbonate fuel cells according to claim 7, wherein the metal particles include at least one selected from the group consisting of silver (Ag), gold (Au), copper (Cu), platinum (Pt), titanium (Ti) and cobalt (Co).

12. The method for manufacturing a cathode for molten carbonate fuel cells according to claim 7, wherein the metal particles are present in an amount of 0.05-30 parts by weight based on 100 parts by weight of the porous nickel-based electrode.

13. The method for manufacturing a cathode for molten carbonate fuel cells according to claim 7, wherein the metal particles have a diameter of 0.001 nm-2 μm.

14. The method for manufacturing a cathode for molten carbonate fuel cells according to claim 7, wherein the cathode has a porosity of 50-85%.

15. The method for manufacturing a cathode for molten carbonate fuel cells according to claim 7, wherein the pores in the cathode have a size of 4-15 μm.
